(19) United States
(12) Patent Application Publication
(10) Pub. No.: US 2022/0263339 A1
(43) Pub. Date: Aug. 18, 2022

(54) Redundant Power Supply Device

(71) Applicant: 3Y POWER TECHNOLOGY (TAIWAN), INC., Taoyuan City (TW)

(72) Inventors: Chuan-Kai Wang, Taoyuan City (TW); Cheng-Yo Xiao, Taoyuan City (TW); Chia-Wei Chen, Taoyuan City (TW)

(73) Assignee: 3Y POWER TECHNOLOGY (TAIWAN), INC., Taoyuan City (TW)

(21) Appl. No.: 17/583,129

(22) Filed: Jan. 24, 2022

(30) Foreign Application Priority Data
Feb. 17, 2021 (TW) 110105286

(51) Int. Cl. H02J 9/06

(52) U.S. Cl. CPC H02J 9/061; H02J 9/068

(57) ABSTRACT

A redundant power supply device comprises a first processing unit, for filtering and rectifying a first input power source, to generate a first output power source; a second processing unit, for filtering and rectifying a second input power source, to generate a second output power source; a common connection unit, coupled to the first processing unit and the second processing unit, for generating a direct current (DC) power source according to the first output power source and the second output power source; and a DC-DC conversion unit, coupled to the common connection unit, for converting the DC power source to a DC output power source.

### BACKGROUND OF THE INVENTION

### 1. Field of the Invention

The present invention relates to a power supply device, and more particularly, to a redundant power supply device.

### 2. Description of the Prior Art

A redundant power supply device increases reliability of power supply via multiple input power sources to solve the problem of power interruption. However, in the prior art, the redundant power supply device is prone to have mechanical failure and reliability issues, if the redundant power supply device has a mechanical switch. In addition, when the redundant power supply device includes multiple boost units (such as power factor correction (PFC) devices) and/or multiple direct current-direct current (DC-DC) conversion units, the redundant power supply device is not only not suitable for small and medium power input power sources, but also causes disadvantages of high cost and large space. Therefore, a redundant power supply device that is suitable for the small and medium power input power sources and saves the cost and the space is an important problem to be solved.

### SUMMARY OF THE INVENTION

One of objectives of the present invention is to provide a redundant power supply device to solve the abovementioned problem.

According to an embodiment of the present invention, a redundant power supply device is disclosed. The redundant power supply device comprises a first processing unit, for filtering and rectifying a first input power source, to generate a first output power source; a second processing unit, for filtering and rectifying a second input power source, to generate a second output power source; a common connection unit, coupled to the first processing unit and the second processing unit, for generating a direct current (DC) power source according to the first output power source and the second output power source; and a DC-DC conversion unit, coupled to the common connection unit, for converting the DC power source to a DC output power source.

The present invention of the redundant power supply device needs fewer components, which means only one DC-DC conversion unit and a set of the common connection unit on the primary side of the DC-DC conversion unit, to accomplish the goal of integrating the first and the second input power sources. Further, the present invention not only solves the problem that the prior art is not suitable for small and medium input power sources, but also improves disadvantages of high cost and large space of the prior art.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a redundant power supply device according to an example of the present invention.

FIG. 2 is a schematic diagram of a processing unit according to an example of the present invention.

FIG. 3 is a schematic diagram of a redundant power supply device according to an example of the present invention.

FIG. 4 is a schematic diagram of a redundant power supply device according to an example of the present invention.

FIG. 5 is a schematic diagram of a redundant power supply device according to an example of the present invention.

FIG. 6 is a schematic diagram of a redundant power supply device according to an example of the present invention.

FIG. 7 is a schematic diagram of a redundant power supply device according to an example of the present invention.

FIG. 8 is a schematic diagram of a redundant power supply device according to an example of the present invention.

FIG. 9 is a schematic diagram of a redundant power supply device according to an example of the present invention.

FIG. 10 is a schematic diagram of a redundant power supply device according to an example of the present invention.

FIG. 11 is a schematic diagram of a redundant power supply device according to an example of the present invention.

FIG. 12 is a schematic diagram of a redundant power supply device according to an example of the present invention.

FIG. 13 is a schematic diagram of a redundant power supply device according to an example of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should not be interpreted as a close-ended term such as “consist of”. Also, the term “couple” is intended to mean either an indirect or direct electrical connection. Accordingly, if one device is coupled to another device, that connection may be through a direct electrical connection, or through an indirect electrical connection via other devices and connections.

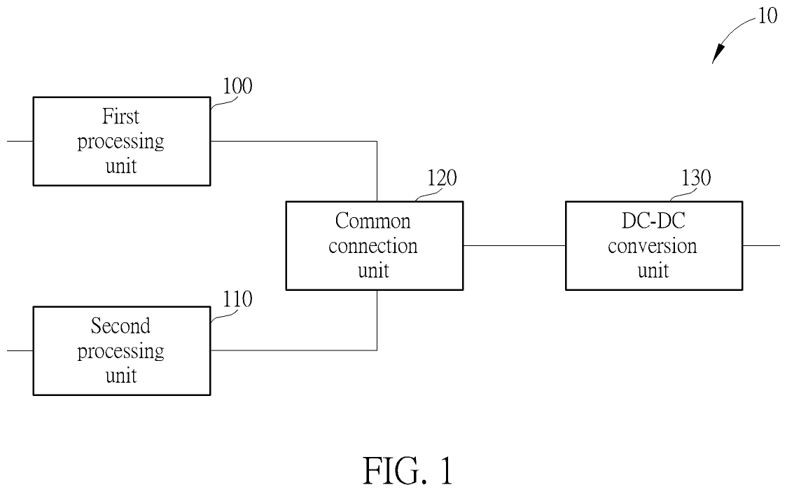

FIG. 1 is a schematic diagram of a redundant power supply device 10 according to an example of the present invention. The redundant power supply device 10 includes a first processing unit 100, a second processing unit 110, a common connection unit 120 and a direct current-direct current (DC-DC) conversion unit 130. It should be noted that FIG. 1 shows a simplified diagram of a redundant power supply device, and components related to the present invention are shown. As known by those skilled in the art, the redundant power supply device may include other related components, and is not limited thereto.

The first processing unit 100 receives a first input power source, wherein the first input power source may be an external power source. The first processing unit 100 filters and rectifies the first input power source, to generate the first output power source. The second processing unit 110 receives a second input power source, wherein the second input power source may be an external power source. The second processing unit 110 filters and rectifies the second input power source, to generate a second output power source. That is, the redundant power supply device 10 may support dual input power sources to increase reliability of power supply.

The common connection unit 120 is coupled to the first processing unit 100 and the second processing unit 110, and receives the first output power source and the second output power source. The common connection unit 120 generates a DC power source according to the first output power source and the second output power source (e.g., the common connection unit 120 converts the first output power source and the second output power source to the DC power source). The DC-DC conversion unit 130 is coupled to the common connection unit 120, and converts the DC power source to a DC output power source (e.g., to supply power to a load). That is, the redundant power supply device 10 performs function-enhanced operations such as the filtering and the rectifying before the common connection unit 120.

In one example, the redundant power supply device 10 may include semiconductor switches. That is, compared with a redundant power supply device with mechanical switches, the redundant power supply device 10 can reduce a probability of mechanical failure. In one example, the common connection unit 120 is a power factor correction (PFC) device, a boost unit or an auxiliary power unit. In one example, the common connection unit 120 is a non-isolated PFC device. Further, the non-isolated PFC device is a single stage PFC device or an interleaved PFC device. That is, the redundant power supply device 10 only includes one PFC device. Thus, the redundant power supply device 10 is better for a low-to-medium power (e.g., input power below 300 watts).

In one example, the DC-DC conversion unit 130 is an isolated DC-DC converter, and the common connection unit 120 is located on a primary side of the isolated DC-DC converter. For example, the DC-DC conversion unit 130 includes a transformer, wherein the transformer includes a primary winding and a secondary winding, and the common connection unit 120 is a primary-side common connection unit.

In one example, the DC-DC conversion unit 130 is an active clamp flyback (ACF) converter, a flyback converter or a LLC resonant converter. Further, the LLC resonant converter may be a full-bridge LLC resonant converter, a half-bridge LLC resonant converter or a phase-shifted full-bridge LLC resonant converter.

In one example, the first input power source is an alternating current (AC) power source or a DC power source, wherein the DC power source is a high-voltage DC (HVDC) power source or a low-voltage DC (LVDC) power source. In one example, the second input power source is an AC power source or a DC power source, wherein the DC power source is a HVDC power source or a LVDC power source. In the above examples, a voltage of the HVDC power source may be between 190 volts and 310 volts, and a voltage of the LVDC power source may be between 36 volts and 75 volts. That is, the redundant power supply device 10 can support inputs of dual AC power sources, inputs of dual DC power sources or a mixed inputs of the AC power source and the DC power source.

In one example, the first processing unit 100 includes at least one of a protection unit, an electromagnetic interference (EMI) filter unit, an electropsychemeter (E-meter) unit or a rectifier unit, wherein the protection unit may be a lightning protector or a power failure and lightning protection unit, and the rectifier unit may be a full-bridge rectifier unit. In one example, the second processing unit 110 includes at least one of a protection unit, an EMI filter unit, an E-meter unit or a rectifier unit, wherein the protection unit may be a lightning protector or a power failure and lightning protection unit, and the rectifier unit may be a full-bridge rectifier unit. That is, the first processing unit 100 and the second processing unit 110 can further perform function-enhanced operations except the operations of filtering and rectifying. For example, when the first processing unit 100 and the second processing unit 110 both include the E-meter unit, the redundant power supply device 10 may detect (such as E-meter detection) different input power sources to measure at least one of an input power, an input current, an input voltage, an input frequency or a power factor of the input power source. In one example, the first processing unit 100 and the second processing unit 110 may be partly the same or completely the same.

It should be noted that the redundant power supply device 10 only needs one DC-DC conversion unit 130 and a set of the common connection unit 120 on the primary side of the DC-DC conversion unit 130, i.e., an integration of the first input power source and the second input power source is achieved via fewer components. Thus, the redundant power supply device 10 can save cost and space.

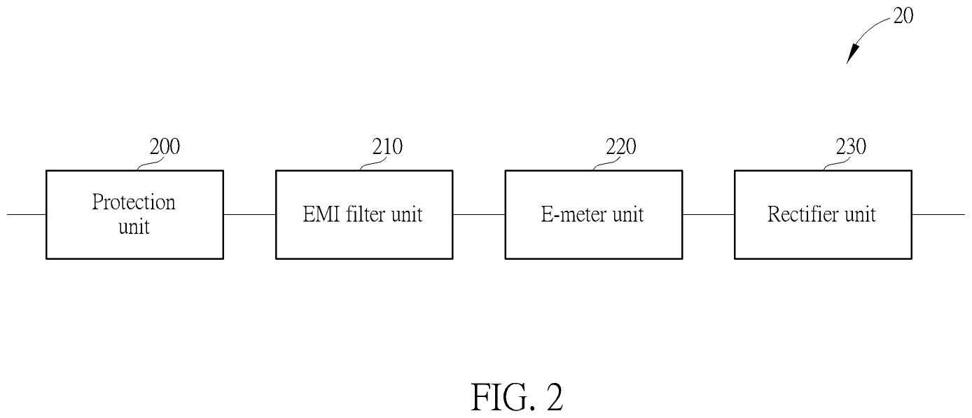

FIG. 2 is a schematic diagram of a processing unit 20 according to an example of the present invention. The processing unit 20 may be used for realizing the first processing unit 100 and/or the second processing unit 110 in FIG. 1, but is not limited thereto. The processing unit 20 includes a protection unit 200, an EMI filter unit 210, an E-meter unit 220 and a rectifier unit 230. The protection unit 200 receives an input power source (e.g., the first input power source or the second input power source), to detect a power supply status of the input power source. According to the detection result, the protection unit 200 generates a protection signal to determine whether to activate a power source protection mechanism. The EMI filter unit 210 is coupled to the protection unit 200, and filters the input power source. The E-meter unit 220 is coupled to the EMI filter unit 210, and performs an E-meter detection on the filtered input power source to measure at least one of an input power, an input current, an input voltage, an input frequency or a power factor. The rectifier unit 230 is coupled to the E-meter unit 220, and rectifies the filtered input power source to generate an output power source (e.g., the first output power source or the second output power source).

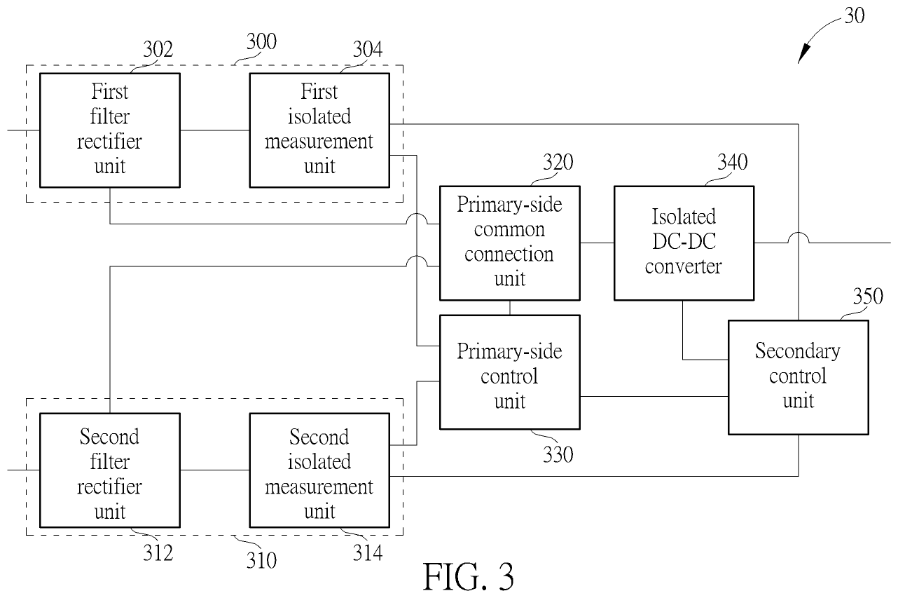

FIG. 3 is a schematic diagram of a redundant power supply device 30 according to an example of the present invention. The redundant power supply device 30 includes a first processing unit 300, a second processing unit 310, a primary-side common connection unit 320 (e.g., primary-side boost type PFC device), a primary-side control unit 330, an isolated DC-DC converter 340 and a secondary control unit 350. It should be noted that FIG. 3 shows a simplified diagram of a redundant power supply device, and components related to the present invention are shown. As known by those skilled in the art, the redundant power supply device may include other related components, and is not limited thereto.

In detail, the first processing unit 300 includes a first filter rectifier unit 302 (e.g., includes an EMI filter unit and a rectifier unit) and a first isolated measurement unit 304 (e.g., isolated E-meter unit). The first filter rectifier unit 302 receives a first input power source, and filters and rectifies the first input power source to generate a first output power source. The first isolated measurement 304 is coupled to the first filter rectifier unit 302, and measures at least one of an input power, an input current, an input voltage, an input frequency or a power factor of the first output power source. The second processing unit 310 includes a second filter rectifier unit 312 (e.g., includes an EMI filter unit and a rectifier unit) and a second isolated measurement unit 314 (e.g., isolated E-meter unit). The second filter rectifier unit 312 receives a second input power source, and filters and rectifies the second input power source to generate a second output power source. The second isolated measurement unit 314 is coupled to the second filter rectifier unit 312, and measures at least one of an input power, an input current, an input voltage, an input frequency or a power factor of the second output power source.

The primary-side common connection unit 320 is coupled to the first filter rectifier unit 302 and the second filter rectifier unit 312, and receives the first output power source and the second output power source. The primary side common connection unit 320 generates a DC power source according to the first output power source and the second output power source. The primary-side control unit 330 is coupled to the first isolated measurement 304, the second isolated measurement unit 314 and the primary-side common connection unit 320, and receives measurement results of the first isolated measurement 304 and/or the second isolated measurement unit 314. The primary-side control unit 330 controls the primary-side common connection unit 320 according to the measurement results. The isolated DC-DC converter 340 is coupled to the primary-side common connection unit 320, and receives the DC power source. The isolated DC-DC converter 340 converts the DC power source to a DC output power source, and transmits the DC output power source to a load.

The secondary control unit 350 is coupled to the first isolated measurement 304, the second isolated measurement unit 314, the primary-side control unit 330 and the isolated DC-DC converter 340. The secondary control unit 350 receives the measurement results of the first isolated measurement 304 and/or the second isolated measurement unit 314, to control the isolated DC-DC converter 340 according to the measurement results. In addition, the secondary control unit 350 may control the primary-side control unit 330 according to the measurement results, to control the primary-side common connection unit 320 indirectly.

In one example, the primary-side common connection unit 320 generates the DC power source according to the second output power source generated by the second processing unit 310, when the first processing unit 300 does not receive the first input power source (e.g., abnormal power supply). That is, power needed by the load is provided by the second input power source of the second processing unit 310.

In one example, the primary-side common connection unit 320 generates the DC power source according to the first output power source generated by the first processing unit 300, when the second processing unit 310 does not receive the second input power source (e.g., abnormal power supply). That is, power needed by the load is provided by the first input power source of the first processing unit 300.

In one example, when the first input power source and the second input power source can be supplied normally, the primary-side control unit 330 can receive the first output power source and the second output power source. For the first output power source and the second output power source, the primary-side control unit 330 can perform power distribution, such that power needed by the load is provided by the first input power source of the first processing unit 300 and the second input power source of the second processing unit 310.

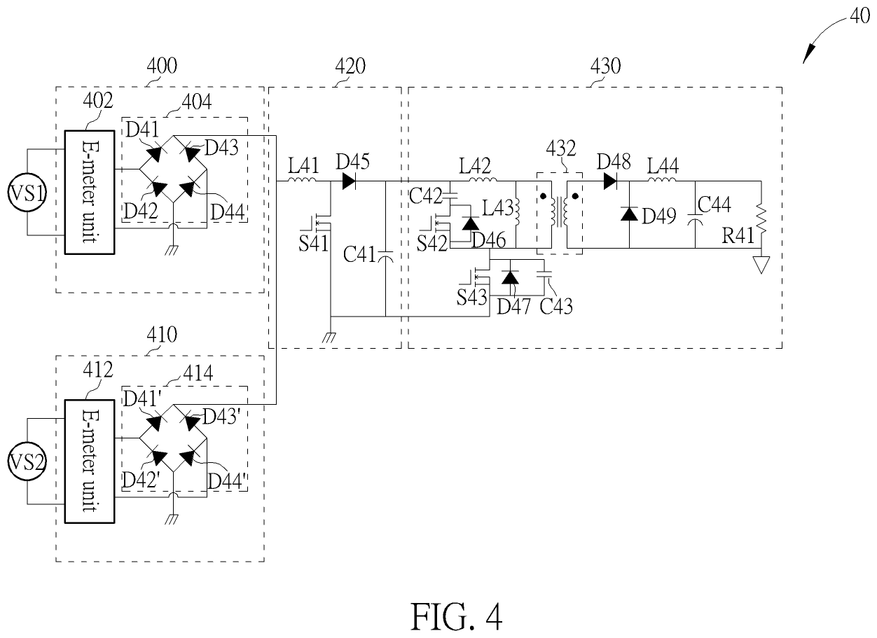

FIG. 4 is a schematic diagram of a redundant power supply device 40 according to an example of the present invention. The redundant power supply device 40 may be used for realizing the redundant power supply device 10 in FIG. 1, but is not limited thereto. The redundant power supply device 40 includes a first processing unit 400, a second processing unit 410, a common connection unit 420 and a DC-DC conversion unit 430. In detail, the first processing unit 400 includes an E-meter unit 402 and a rectifier unit 404. The E-meter unit 402 receives a first input power source VS1, wherein the first input power source VS1 may be an AC power source, a HVDC power source or a LVDC power source. The E-meter unit 402 performs an E-meter detection on the first input power source VS1, to measure at least one of a power, a current, a voltage, an input frequency or a power factor. In the present example, the rectifier unit 404 may be realized by a full bridge diode rectifier including diodes D41-D44. The rectifier unit 404 is coupled to the E-meter unit 402, and rectifies the first input power source VS1, to generate a first output power source. The second processing unit 410 includes an E-meter unit 412 and a rectifier unit 414. The E-meter unit 412 receives a second input power source VS2, wherein the second input power source VS2 can be an AC power source, a HVDC power source or a LVDC power source. The E-meter unit 412 performs an E-meter detection on the second input power source VS2, to measure at least one of a power, a current, a voltage, an input frequency or a power factor. In the present example, the rectifier unit 414 may be realized by a full bridge diode rectifier including diodes D41′-D44′. The rectifier unit 414 is coupled to the E-meter unit 412, and rectifies the second input power source VS2, to generate a second output power source.

According to FIG. 4, the common connection unit 420 can be realized by a single-stage PFC device. The common connection unit 420 is coupled to the rectifier units 404 and 414, and receives the first output power source and the second output power source, to generate a DC power source. In detail, the common connection unit 420 includes an inductor L41, a transistor S41, a diode D45 and a capacitor C41. The common connection unit 420 may have 2 states. In the first state, when the transistor S41 is conducting, the inductor L41 is charged and a current of the inductor L41 is increased according to a slope until the transistor S41 is not conducting. In the second state, after the transistor S41 is not conducting, the diode D45 is conducting and a voltage of the inductor L41 charges the capacitor C41 via the diode D45 until the transistor S41 is conducting.

According to FIG. 4, the DC-DC conversion unit 430 can be realized by the ACF converter. The DC-DC conversion unit 430 is coupled to the common connection unit 420, and converts the DC power source to a DC output power source. Further, the DC-DC conversion unit 430 may have 10 states. In the first state, the transistor S43 is conducting, and the transistor S42 is not conducting. A secondary side of the DC-DC conversion unit 430 is in a commutation state (e.g., the diodes D48 and D49 are conducting) until the diode D49 is not conducting, i.e., a current of the diode D49 is 0. In the second state, the diode D49 is not conducting, and the DC power source charges the capacitor C42 and the inductor L43. A transformer 432 transmits energy of the primary side to the secondary side, and provides the energy to the load, the inductor L44 and the capacitor C44 via the diode D48. Thus, the inductor L44 and the capacitor C44 are charged until the transistor S43 is not conducting. In the third state, after the transistor S43 is not conducting, the transformer 432 continues transmitting energy of the primary side. A current of the inductor L42 charges the capacitor C43 linearly until a voltage of the capacitor C43 is close to a voltage of the DC power source.

In the fourth state, when the voltage of the capacitor C43 is close the voltage of the DC power source, the diodes D48 and D49 are conducting at the same time, and the transformer 432 turns into a short-circuit state, i.e., a voltage of the inductor L43 is close to 0. Thus, in the fourth state, the secondary side of the DC-DC conversion unit 430 belongs to a freewheeling state, and the power needed by the load is provided by the inductor L44 and the capacitor C44. In addition, the inductor L42 and the capacitor C43 generate resonance, and the voltage of capacitor C43 can be charged quickly until the voltage of the capacitor C43 is close to a sum of the voltage of the DC power source and a voltage of the capacitor C42. In the fifth state, when the voltage of capacitor C43 is close to the sum of the voltage of DC power source and the voltage of the capacitor C42, the transistor D46 is conducting and the transistor S42 can perform a zero-voltage switching (ZVS). The current of the inductor L42 decreases according to a slope until the transistor D48 is not conducting.

In the sixth state, after the transistor D48 is not conducting, the transformer 432 stops the short-circuit state and a cross voltage of the primary side winding of the transformer 432 is close to a negative value of the voltage of the capacitor C42. The inductors L42 and L43 can perform a leakage operation, e.g., the current of the inductor L42 decreases according to a slope, and the capacitor C42 stores energy until the current of the inductor L42 is close to 0. In the seventh state, the current of the capacitor C42 starts to reverse until the transistor S42 is not conducting. In the eighth state, the cross voltage of the transformer 432 is negative. Thus, the diode D48 is not conducting, and the diode D49 is conducting. After the transistor S42 is not conducting, the voltage of the capacitor C43 charges the inductors L42 and L43 and the voltage of the capacitor C43 decreases until the voltage of the capacitor C43 is close to the voltage of the DC power source. According to the energy stored by the inductor L42, the transistor S43 can perform the ZVS in a next stage (i.e., the ninth state). In the ninth state, when the voltage of the capacitor C43 is close to the voltage of the DC power source, the current of the diode D48 increases and the current of the diode D49 decreases, i.e., the diodes D48 and D49 are conducting at the same time. Thus, the transformer 432 turns into the short-circuit state, and the inductor L42 and the capacitor C43 generate the resonance. In the tenth state, the diode D47 is conducting, and according to the voltage of the DC power source, the current of the inductor L42 increases quickly according to a slope (since the voltage of the inductor L43 is 0) until the transistor S43 is conducting.

In one example, the capacitor C42 is greater than the capacitor C43. In one example, the inductor L42 is smaller than the inductor L43. In one example, energy stored in the inductor L42 is greater than energy stored in the capacitor C43, so that the transistor S43 performs the ZVS. In one example, grounds of the first processing unit 400, the second processing unit 410 and the common connection unit 420 are a ground of the primary side, and a ground of the DC-DC conversion unit 430 is a ground of the secondary side.

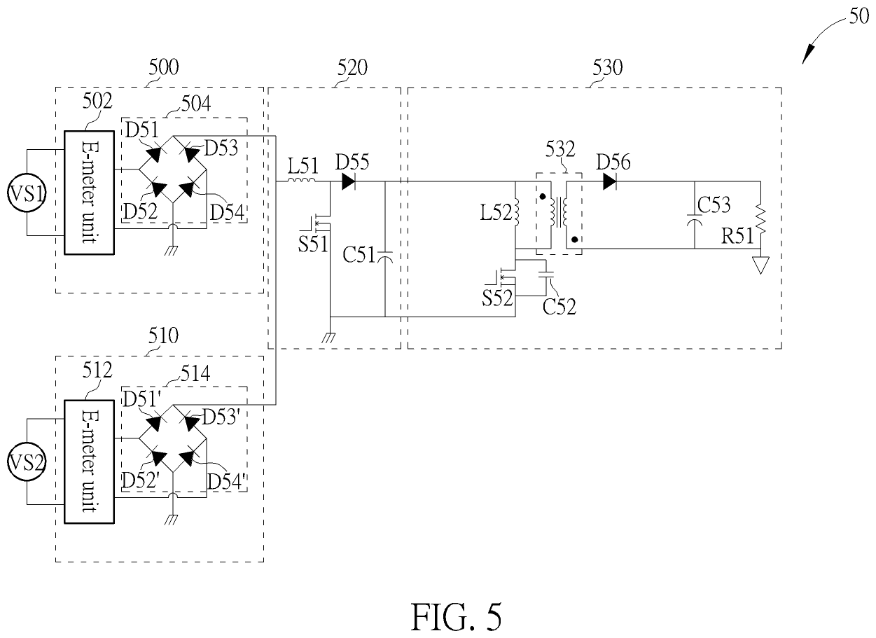

FIG. 5 is a schematic diagram of a redundant power supply device 50 according to an example of the present invention. The redundant power supply device 50 may be used for realizing the redundant power supply device 10 in FIG. 1, but is not limited thereto. The redundant power supply device 50 includes a first processing unit 500, a second processing unit 510, a common connection unit 520 and a DC-DC conversion unit 530. The operations and the examples of the first processing unit 400, the second processing unit 410 and the common connection unit 420 in FIG. 4 can be applied to the first processing unit 500, the second processing unit 510 and the common connection unit 520, respectively, the details are omitted here.

According to FIG. 5, the DC-DC conversion unit 530 may be realized by a flyback converter. The DC-DC conversion unit 530 is coupled to the common connection unit 520, and converts a DC power source to a DC output power source. Further, the DC-DC conversion unit 530 have 2 states. In the first state, when a transistor S52 is conducting, a primary side of a transformer 532 starts to receive a current and an inductor L52 is charged. In addition, a polarity of a primary side winding and a polarity of a secondary winding in the transformer 532 are opposite, so that a diode D56 may be reverse biased, i.e., the diode D56 is not conducting. That is, a power needed by a load is provided by a capacitor C53. In the second state, the diode D56 is conducting, when the transistor S52 is not conducting. The transformer 532 transmits energy stored in the inductor L52 to the secondary side, and provides the energy to the load and the capacitor C53 via the diode D56. Thus, the capacitor C53 is charged.

In one example, a ground of the DC-DC conversion unit 530 is a ground of the secondary side.

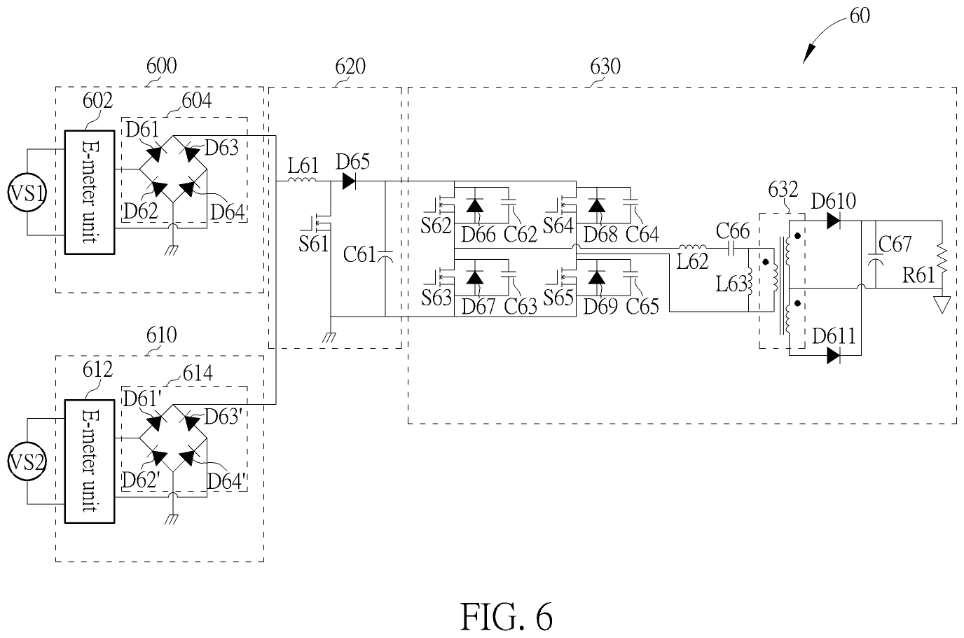

FIG. 6 is a schematic diagram of a redundant power supply device 60 according to an example of the present invention. The redundant power supply device 60 may be used for realizing the redundant power supply device 10 in FIG. 1, but is not limited thereto. The redundant power supply device 60 includes a first processing unit 600, a second processing unit 610, a common connection unit 620 and a DC-DC conversion unit 630. The operations and the examples of the first processing unit 400, the second processing unit 410 and the common connection unit 420 in FIG. 4 can be applied to the first processing unit 600, the second processing unit 610 and the common connection unit 620, respectively, the details are omitted here.

According to FIG. 6, the DC-DC conversion unit 630 may be realized by a full-bridge LLC resonant converter. The DC-DC conversion unit 630 is coupled to the common connection unit 620, and converts a DC power source to a DC output power source. Further, the DC-DC conversion unit 630 have two resonance frequencies. The first resonance frequency is generated according to an inductor L62 and a capacitor C66, and the second resonance frequency is generated according to the inductor L62, an inductor L63 and the capacitor C66.

For example, the DC-DC conversion unit 630 may have 8 states. In the first state, a transistor S62 and a transistor S65 may perform a ZVS (i.e., the transistor S62 and the transistor S65 are conducting), and a transistor S63 and a transistor S64 are not conducting. A transistor D610 is conducting, and a transistor D611 is not conducting. A transformer 632 transmits energy of a primary side to a secondary side, and provides the energy to a load via the diode D610 until a current of the inductor L62 and a current of the inductor L63 are the same. A voltage of the DC output power source clamps a voltage of the inductor L63. Thus, the capacitor C66 and the inductor L62 generate resonance, a current of the inductor L62 is changed according to a sinusoidal waveform, and a current of the inductor L63 increases linearly. In the second state, when the current of the inductor L62 and the current of the inductor L63 are the same, the diodes D610 and D611 are not conducting and the transformer 632 turns into a short-circuit state. A power needed by the load is provided by a capacitor C67. In addition, the voltage of the DC output power source does not clamp the voltage of inductor L63. Thus, the capacitor C66, the inductors L62 and L63 generate the resonance, wherein a resonance period in the second state may be greater than a resonance period in the first state. The current of the inductor L62 may charge the capacitor C66 until the transistor S62 is not conducting.

In the third state, the transistors S62, S63, S64 and S65 are not conducting. The capacitors C64 and C65 are charged, and the capacitors C62 and C63 are discharged. In the fourth state, the transistors S62, S63, S64 and S65 are not conducting. The diodes D67 and D68 can perform ZVS, i.e., the diodes D67 and D68 are conducting. The diode D610 is not conducting, and the diode D611 is conducting. The transformer 632 transmits energy of the primary side to the secondary side, and provides the energy to the load and the capacitor C67 via the diode D611. The voltage of the DC output power source clamps the voltage of the inductor L63. Thus, the capacitor C66 and inductor L62 generate the resonance. In the fifth state, the transistor S63 and the transistor S64 are conducting, and the diode D611 continues conducting. The transformer 632 transmits the energy of the primary side to the secondary side, and provides the energy to the load and the capacitor C67 via the diode D611 until the current of the inductor L62 and the current of the inductor L63 are the same.

In the sixth state, when the current of the inductor L62 and the current of the inductor L63 are the same, the diode D611 can perform a zero-current switching (ZCS) (i.e., the diode D611 is not conducting) and the transformer 632 turns into the short-circuit state. The power needed by the load is provided by the capacitor C67. The voltage of the DC output power source does not clamp the voltage of the inductor L63. Thus, the capacitor C66, the inductors L62 and L63 generate the resonance. In the seventh state, the transistors S62, S63, S64 and S65 are not conducting. The capacitors C62 and C65 are charged until the diodes D66 and D69 are conducting. In the eighth state, the transistors S62, S63, S64 and S65 are not conducting, and the diode D610 is conducting. The voltage of the DC output power source clamps the voltage of the inductor L63. Thus, the capacitor C66 and the inductor L62 generates the resonance.

In one example, a ground of the DC-DC conversion unit 630 is a ground of the secondary side.

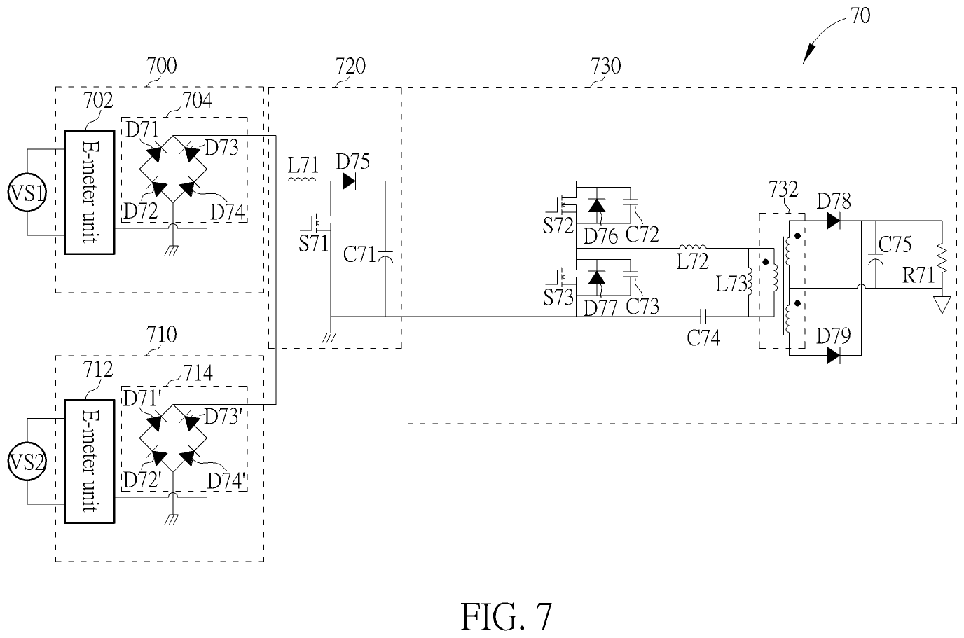

FIG. 7 is a schematic diagram of a redundant power supply device 70 according to an example of the present invention. The redundant power supply device 70 may be used for realizing the redundant power supply device 10 in FIG. 1, but is not limited thereto. The redundant power supply device 70 includes a first processing unit 700, a second processing unit 710, a common connection unit 720 and a DC-DC conversion unit 730. The operations and the examples of the first processing unit 400, the second processing unit 410 and the common connection unit 420 in FIG. 4 can be applied to the first processing unit 700, the second processing unit 710 and the common connection unit 720, respectively, the details are omitted here.

According to FIG. 7, the DC-DC conversion unit 730 may be realized by a half-bridge LLC resonant converter. The DC-DC conversion unit 730 is coupled to the common connection unit 720, and converts a DC power source to a DC output power source. Further, operation time of the transistors S72 and S73 may be close to half of a working period, and the transistors S72 and S73 can be controlled by a complementary frequency modulation control method. The DC-DC conversion unit 730 may have two resonance frequencies. The first resonance frequency is generated according to the inductor L72 and the capacitor C74, and the second resonance frequency is generated according to the inductor L72, the inductor L73 and the capacitor C74.

The DC-DC conversion unit 730 may have 8 states. In the first state, the transistor S72 is conducting, and the transistor S73 is not conducting. A current of the inductor L72 flows through the transistor S72, and currents of the inductors L72 and L73 increase. The transformer 732 transmits energy of a primary side to a secondary side, and provides the energy to a load via the diode D78 until the current of the inductor L72 and the current of the inductor L73 are the same. A voltage of the DC output power source clamps of a voltage of the inductor L73. Thus, the capacitor C74 and the inductor L72 generates resonance. In the second state, the transistor S72 continues conducting, and the transistor S73 continues not conducting. When the current of the inductor L72 and the current of the inductor L73 are the same, the transformer 732 turns into a short-circuit state and the diodes D78 and D79 are not conducting. Power needed by the load is provided by the capacitor C75. In addition, the voltage of the DC output power source does not clamp the voltage of the inductor L73. Thus, the capacitor C74 and the inductors L72 and L73 generate the resonance. A resonance period in the second period is greater than a resonance period in the first state. The current of the inductor L73 may be seen as a constant current source until the transistor S72 is not conducting.

In the third state, after the transistors S72 and S73 are not conducting, the current of the inductor L72 and the current of the inductor L73 continues being the same and the transformer 732 continues being in the short-circuit state. The capacitor C72 is charged, and the capacitor C73 discharges until the voltage of capacitor C72 increases to the voltage of the DC power source and the voltage of the capacitor C73 decreased to 0. The power needed by the load is provided by the capacitor C75 until the diode D77 is conducting. In the fourth state, the transistors S72 and S73 continues not conducting. The diode D77 is conducting until the transistor S73 is conducting, so that the transistor S73 can perform a ZVS in a next state (i.e., the fifth state). The voltage of the inductor L73 switches to a reverse direction, and the diode D79 is conducting. The current of the inductor L72 flows through the inductor L73 and the diode D77, wherein the current of the inductor L72 is smaller than the current of the inductor L73.

In the fifth state, the transistor S73 can perform the ZVS, and the transistor S72 continues not conducting. The current of the inductor L72 increases in a reverse direction, and the current of the inductor L73 decreases linearly, wherein the current of the inductor L73 is greater than the current of the inductor L72. The diode D79 is conducting until the current of the inductor L73 and the current of the inductor L72 are the same. In the sixth state, the transistor S73 continues conducting, and the transistor S72 continues not conducting. When the current of the inductor L73 and the current of the inductor L72 are the same, the transformer 732 turns into the short-circuit state, and the diode D79 can perform a ZCS. The voltage of the DC output power source does not clamp the voltage of the inductor L73. Thus, the capacitor C74 and the inductors L72 and L73 generate the resonance, wherein a resonance frequency of the resonance may be the second resonance frequency. The resonance period in the second period is greater than the resonance period in the first state. The current of the inductor L73 may be seen as the constant current source until the transistor S73 is not conducting. In this state, the power needed by the load is provided by the capacitor C75.

In the seventh state, the transistor S73 and the transistor S72 are not conducting. The current of the inductor L72 and the current of the inductor L7 continue being the same, and the transformer 732 continues being in the short-circuit state. The capacitor C75 provides the power needed by the load. The capacitor C73 is charged, and the voltage of the capacitor C73 increases to the voltage of the DC power source. The capacitor C72 discharges, and the voltage of the capacitor C72 decreases to 0. In the eighth state, the transistor S73 and the transistor S72 are not conducting. The diode D76 is conducting until the transistor S72 is conducting, so that the transistor S72 can perform the ZVS in a next state (i.e., a first state in next working period). The current of the inductor L72 increases, and flows through the inductor L73 and the diode D76. The current of the inductor L73 increases, and the inductor L73 stores energy. The diode D78 is conducting. The transformer 732 transmits energy of the primary side to the secondary side, and provides the energy to the load via the diode D78.

In one example, a ground of the DC-DC conversion unit 730 is a ground of the secondary side.

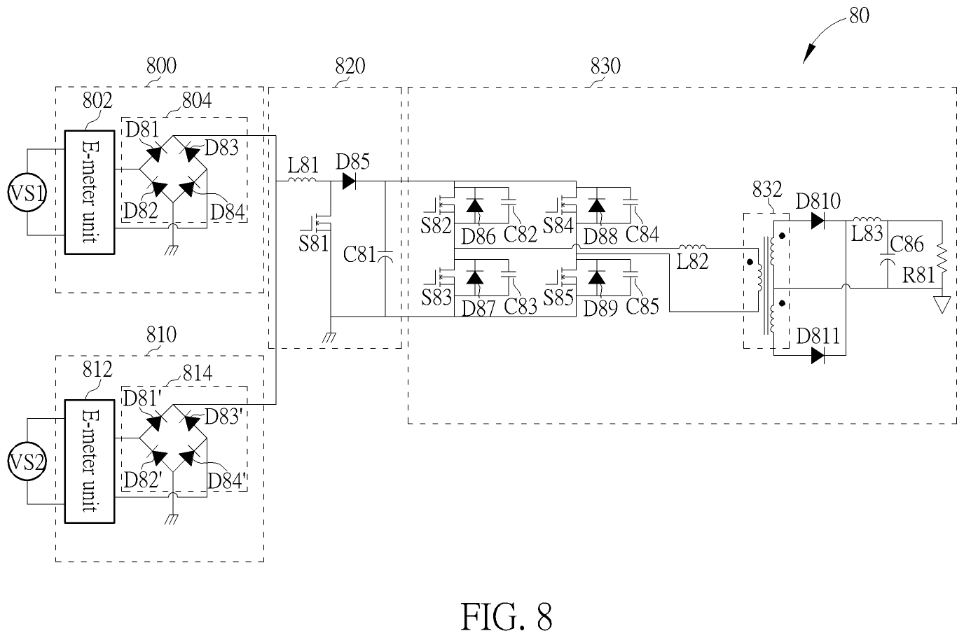

FIG. 8 is a schematic diagram of a redundant power supply device 80 according to an example of the present invention. The redundant power supply device 80 may be used for realizing the redundant power supply device 10 in FIG. 1, but is not limited thereto. The redundant power supply device 80 includes a first processing unit 800, a second processing unit 810, a common connection unit 820 and a DC-DC conversion unit 830. The operations and the examples of the first processing unit 400, the second processing unit 410 and the common connection unit 420 in FIG. 4 can be applied to the first processing unit 800, the second processing unit 810 and the common connection unit 820, respectively, the details are omitted here.

According to FIG. 8, the DC-DC conversion unit 830 may be realized by a phase-shifted full-bridge LLC resonant converter. The DC-DC conversion unit 830 is coupled to the common connection unit 820, and converts a DC power source to a DC output power source. Further, the DC-DC conversion unit 830 may have 5 states. In the first state, the transistors S85 and S82 are conducting. The diode D810 is conducting, and a diode D811 is not conducting. A current of a primary side of the transformer 832 increases, and the transformer 832 transmits energy of the primary side to a secondary side to charge an inductor L83. In the second state, the transistor S82 is not conducting, and the current of the primary side of the transformer 832 stops increasing. A current of an inductor L82 charges a capacitor C82, and the capacitor C83 discharges until a voltage of the capacitor C82 to a voltage of the DC power source and a voltage of a capacitor C83 decreases to 0.

In the third state, after the diode D87 is conducting, the transistor S83 may perform a ZVS. The transformer 832 transmits energy of the inductor L82 to the secondary side. In the fourth state, the transistor S85 is not conducting. The capacitor C85 is charged, and the capacitor C84 is discharged until the voltage of the capacitor C85 increases to the voltage of the DC power source and the voltage of the capacitor C84 decreases to 0. The transformer 832 turns into the short-circuit state. In the fifth state, after a diode D88 is conducting, the transistor S84 can perform the ZVS. A voltage of the inductor L82 is close to the voltage of the DC power source, and the current of the primary side of the transformer 832 decreases until an absolute value of the current of the primary side is greater than or equal to a reflected current of the inductor L83. The transformer 832 stops the short-circuit state.

In one example, a ground of the DC-DC conversion unit 830 is a ground of the secondary side.

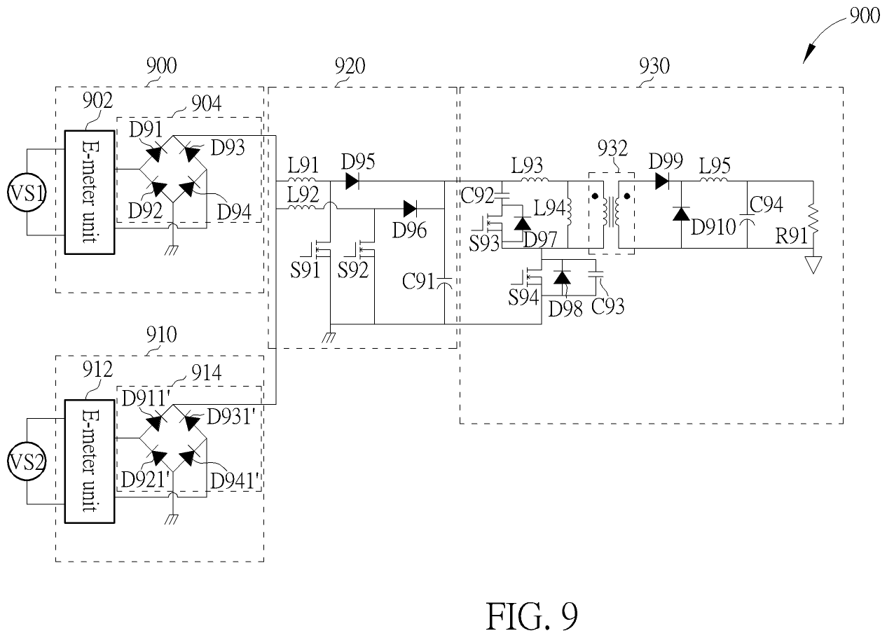

FIG. 9 is a schematic diagram of a redundant power supply device 90 according to an example of the present invention. The redundant power supply device 90 may be used for realizing the redundant power supply device 10 in FIG. 1, but is not limited thereto. The redundant power supply device 90 includes a first processing unit 900, a second processing unit 910, a common connection unit 920 and a DC-DC conversion unit 930. The operations and the examples of the first processing unit 400, the second processing unit 410 and the DC-DC conversion unit 430 in FIG. 4 can be applied to the first processing unit 900, the second processing unit 910 and the DC-DC conversion unit 930, respectively, the details are omitted here.

According to FIG. 9, the common connection unit 920 can be realized by an interleaved PFC device. Further, the common connection unit 920 is coupled to rectifier units 904 and 914, and includes two single-stage PFC devices. Further, phase difference between driving signals of the transistors S91 and S92 is 180 degrees, and phase difference of current waveforms of inductors L91 and L92 is 180 degrees. Thus, a ripple current is reduced, and a frequency of the ripple current increases. It should be noted that operation modes of the two single-stage PFC devices of the common connection unit 920 are the same. The following operations related to the inductor L91, the transistor S91 and the diode D95 may be applied the inductor L92, the transistor S92 and the diode D96, respectively, the details are omitted here. The single-stage PFC device of the common connection unit 920 may have two states. In the first state, when the transistor S91 is conducting, the inductor L91 is charged, and a current of the inductor L91 increases according to a slope until the transistor S91 is not conducting. In the second state, after the transistor S91 is not conducting, the diode D95 is conducting and a voltage of the inductor L91 charges the capacitor C91 via the diode D95 until the transistor S41 is conducting.

In one example, a ground of the common connection unit 920 is a ground of the primary side.

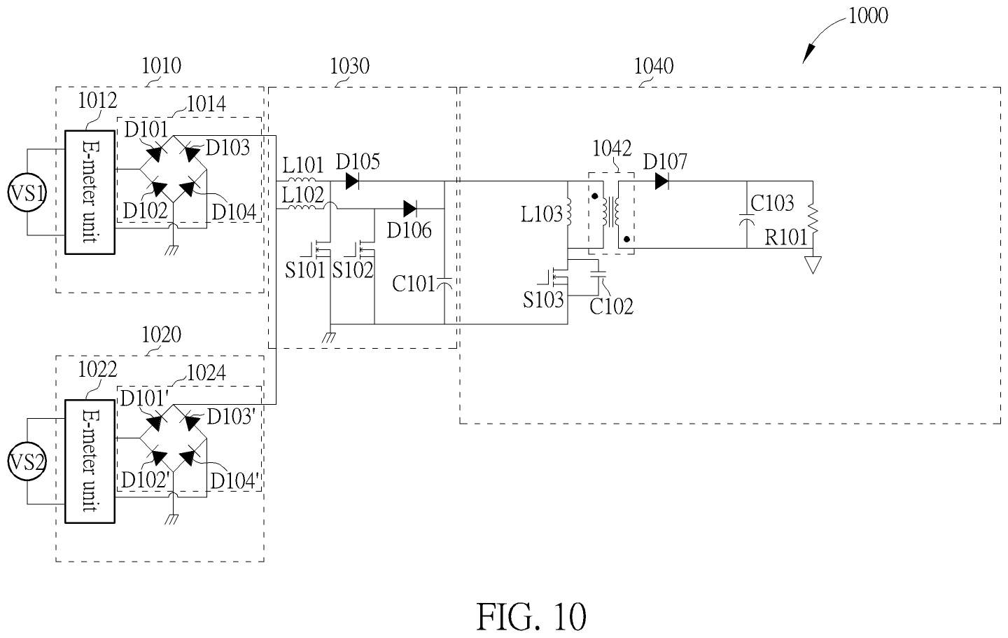

FIG. 10 is a schematic diagram of a redundant power supply device 1000 according to an example of the present invention. The redundant power supply device 1000 may be used for realizing the redundant power supply device 10 in FIG. 1, but is not limited thereto. The redundant power supply device 1000 includes a first processing unit 1010, a second processing unit 1020, a common connection unit 1030 and a DC-DC conversion unit 1040. The operations and the examples of the first processing unit 400 and the second processing unit 410 in FIG. 4 can be applied to the first processing unit 1010 and the second processing unit 1020, respectively, but is not limited thereto. The operation and the example of the common connection unit 920 in FIG. 9 can be applied to the common connection unit 1030, the details are omitted here. The operation and the example of the DC-DC conversion unit 530 in FIG. 5 can be applied to the DC-DC conversion unit 1040, the details are omitted here.

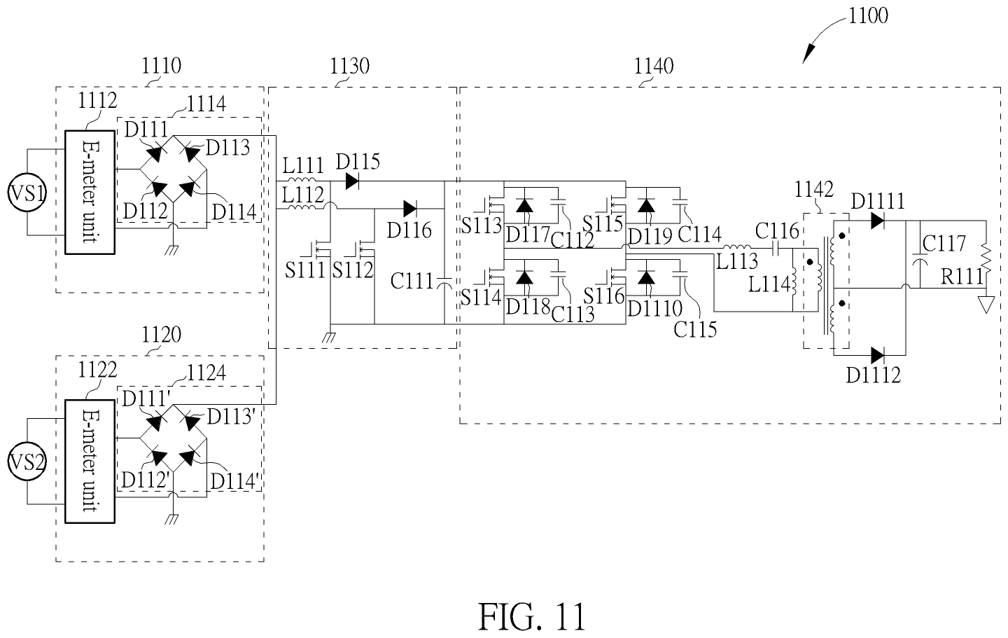

FIG. 11 is a schematic diagram of a redundant power supply device 1100 according to an example of the present invention. The redundant power supply device 1100 may be used for realizing the redundant power supply device 10 in FIG. 1, but is not limited thereto. The redundant power supply device 1100 includes a first processing unit 1110, a second processing unit 1120, a common connection unit 1130 and a DC-DC conversion unit 1140. The operations and the examples of the first processing unit 400 and the second processing unit 410 in FIG. 4 can be applied to the first processing unit 1110 and the second processing unit 1120, respectively, the details are omitted here. The operation and the example of the common connection unit 920 in FIG. 9 can be applied to the common connection unit 1130, the details are omitted here. The operation and the example of the DC-DC conversion unit 630 in FIG. 6 can be applied to the DC-DC conversion unit 1140, the details are omitted here.

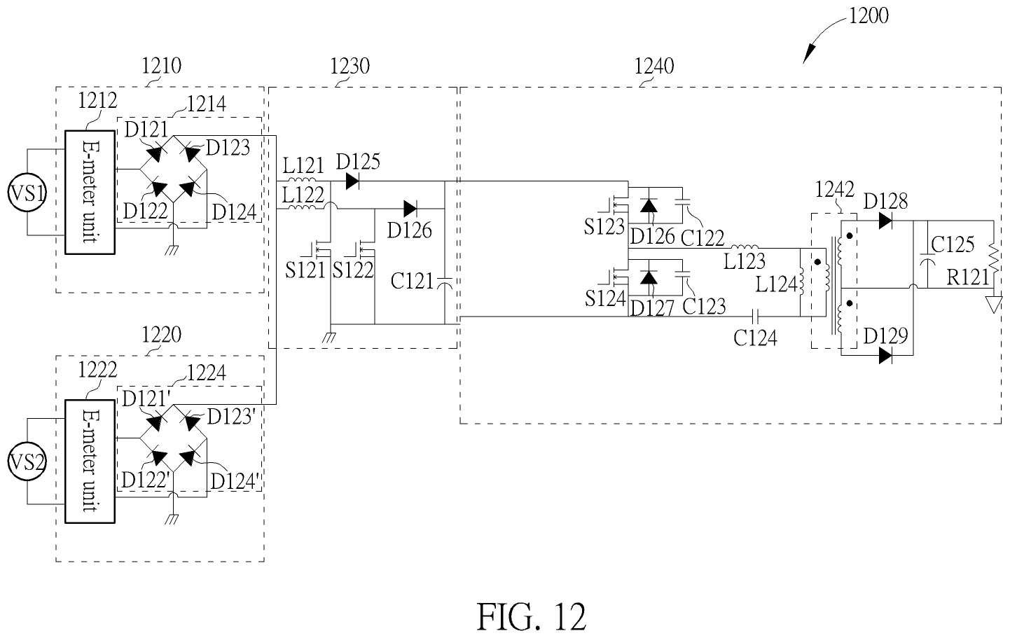

FIG. 12 is a schematic diagram of a redundant power supply device 1200 according to an example of the present invention. The redundant power supply device 1200 may be used for realizing the redundant power supply device 10 in FIG. 1, but is not limited thereto. The redundant power supply device 1200 includes a first processing unit 1210, a second processing unit 1220, a common connection unit 1230 and a DC-DC conversion unit 1240. The operations and the examples of the first processing unit 400 and the second processing unit 410 in FIG. 4 can be applied to the first processing unit 1210 and the second processing unit 1220, respectively, the details are omitted here. The operation and the example of the common connection unit 920 in FIG. 9 can be applied to the common connection unit 1230, the details are omitted here. The operation and the example of the DC-DC conversion unit 730 in FIG. 7 can be applied to the DC-DC conversion unit 1240, the details are omitted here.

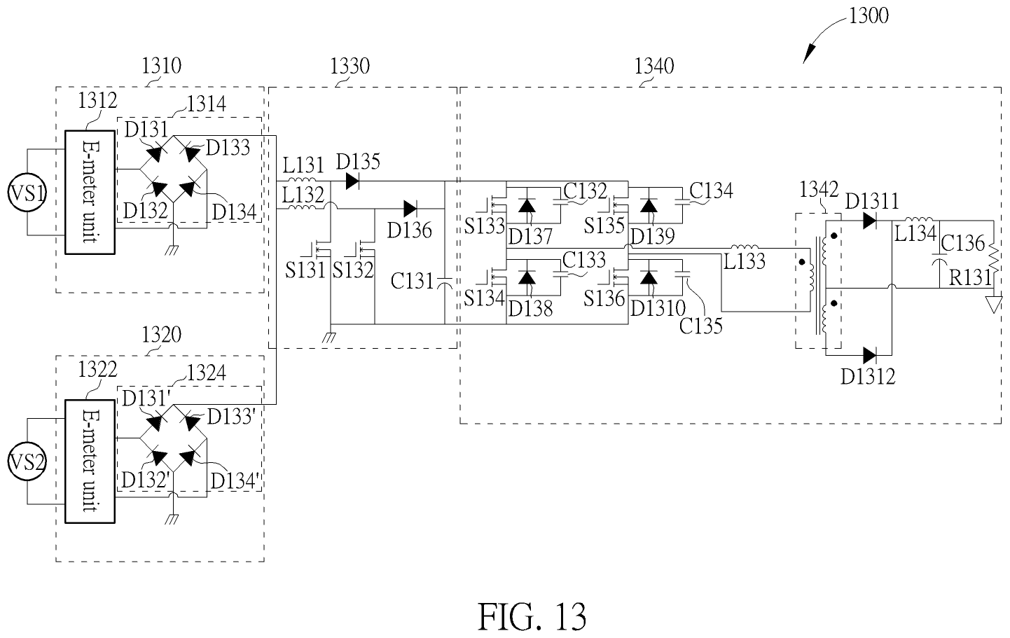

FIG. 13 is a schematic diagram of a redundant power supply device 1300 according to an example of the present invention. The redundant power supply device 1300 may be used for realizing the redundant power supply device 10 in FIG. 1, but is not limited thereto. The redundant power supply device 1300 includes a first processing unit 1310, a second processing unit 1320, a common connection unit 1330 and a DC-DC conversion unit 1340. The operations and the examples of the first processing unit 400 and the second processing unit 410 in FIG. 4 can be applied to the first processing unit 1310 and the second processing unit 1320, respectively, the details are omitted here. The operation and the example of the common connection unit 920 in FIG. 9 can be applied to the common connection unit 1330, the details are omitted here. The operation and the example of the DC-DC conversion unit 830 in FIG. 8 can be applied to the DC-DC conversion unit 1340, the details are omitted here.

To sum up, the present invention provides a redundant power supply device. The present invention not only solves the problem that the prior art is not suitable for small and medium input power sources, but also improves disadvantages of high cost and large space of the prior art.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A redundant power supply device, comprising:
a first processing unit, for filtering and rectifying a first input power source, to generate a first output power source;
a second processing unit, for filtering and rectifying a second input power source, to generate a second output power source;
a common connection unit, coupled to the first processing unit and the second processing unit, for generating a direct current (DC) power source according to the first output power source and the second output power source; and
a DC-DC conversion unit, coupled to the common connection unit, for converting the DC power source to a DC output power source.

2. The redundant power supply device of claim 1, wherein the common connection unit is a non-isolated power factor correction (PFC) device.

3. The redundant power supply device of claim 2, wherein the DC-DC conversion unit is an isolated DC-DC converter, and the common connection unit is located on a primary side of the isolated DC-DC converter.

4. The redundant power supply device of claim 1, wherein the DC-DC conversion unit is an isolated DC-DC converter, and the common connection unit is located on a primary side of the isolated DC-DC converter.

5. The redundant power supply device of claim 1, wherein the DC-DC conversion unit is an active clamp flyback (ACF) converter, a flyback converter or a LLC resonant converter.

6. The redundant power supply device of claim 5, wherein the LLC resonant converter is a full-bridge LLC resonant converter, a half-bridge LLC resonant converter or a phase-shifted full-bridge LLC resonant converter.

7. The redundant power supply device of claim 1, wherein the first input power source is an alternating current (AC) power source or a DC power source.

8. The redundant power supply device of claim 1, wherein the second input power source is an AC power source or a DC power source.

9. The redundant power supply device of claim 1, wherein the first processing unit comprises at least one of a protection unit, an electromagnetic interference (EMI) filter unit, an electropsychemeter (E-meter) unit and a rectifier unit.

10. The redundant power supply device of claim 1, wherein the second processing unit comprises at least one of a protection unit, an EMI filter unit, an E-meter unit and a rectifier unit.
